(19) United States
(12) Patent Application Publication
(10) Pub. No.: US 2015/0187484 A1
(43) Pub. Date: Jul. 2, 2015

(54) CHIP ELECTRONIC COMPONENT

(71) Applicant: SAMSUNG ELECTRO-MECHANICS CO., LTD., Suwon-Si (KR)

(72) Inventors: Dong Jin JEONG, Suwon-Si (KR); Yong Un CHOI, Suwon-Si (KR)

(73) Assignee: SAMSUNG ELECTRO-MECHANICS CO., LTD., Suwon-Si (KR)

(21) Appl. No.: 14/284,209

(22) Filed: May 21, 2014

(30) Foreign Application Priority Data
Jan. 2, 2014 (KR) 10-2014-0000138

(51) Int. Cl. H01F 27/28; H01F 27/24

(52) U.S. Cl. CPC H01F 27/2804; H01F 27/24; H01F 2027/2809

(57) ABSTRACT

There is provided a chip electronic component comprising: a magnetic body including an insulating substrate; an internal coil part formed on at least one surface of the insulating substrate; and an external electrode formed on at least one end surface of the magnetic body and connected to the internal coil part, wherein the internal coil part includes an outermost coil pattern portion, an innermost coil pattern portion and a central coil pattern portion, widths of the outermost and innermost coil pattern portions being greater than a width of the central coil pattern portion.

### CROSS-REFERENCE TO RELATED APPLICATION

This application claims the benefit of Korean Patent Application No. 10-2014-0000138 filed on Jan. 2, 2014, with the Korean Intellectual Property Office, the disclosure of which is incorporated herein by reference.

### BACKGROUND

The present disclosure relates to a chip electronic component.

An inductor, which is one of chip electronic components, is a representative passive element configuring an electronic circuit together with a resistor and a capacitor to remove noise. The inductor is combined with the capacitor using electromagnetic properties to configure a resonance circuit amplifying a signal in a specific frequency band, a filter circuit, or the like.

Recently, as miniaturization and thinness of information technology (IT) devices, such as various communications devices, display devices, or the like, has been accelerated, research into a technology for miniaturizing and thinning various elements such as an inductor, a capacitor, a transistor, and the like, used in the IT devices has been continuously conducted. The inductor has also been rapidly replaced by a chip having a small size and a high density and capable of being automatically surface-mounted, and a thin film inductor in which a mixture of magnetic powder and resin is formed on coil patterns formed on upper and lower surfaces of a thin film insulating substrate through plating has been developed.

A direct current (DC) resistance value Rdc, which is one of the main characteristics of the inductor, is decreased as a cross-sectional area of a coil is increased. In addition, an inductance value L of the inductor is changed depending on an area of an internal magnetic part through which magnetic fluxes pass.

Therefore, in order to decrease the DC resistance value Rdc and increase the inductance value L, a cross-sectional area of an internal coil needs to be increased and the area of the internal magnetic part needs to be increased.

There are two methods of increasing the cross-sectional area of the coil. One is to increase a width of the coil and the other one is to increase a thickness of the coil.

In the case of increasing the width of the coil, a risk that a short-circuit will occur between the coils may be significantly increased, and the number of turns in an inductor chip may be decreased, which leads to a decrease in an area occupied by a magnetic part, whereby product efficiency is decreased, and there is a limitation in implementing high capacitance in the product.

Therefore, according to the related art, an attempt to decrease the DC resistance value Rdc and increase the inductance value L by increasing the thickness of the coil without increasing the width of the coil has been conducted. However, it has been difficult to suppress growth of the coil in a width direction and only promote growth of the coil in a thickness direction. Therefore, there has been a limitation in decreasing the DC resistance value Rdc and increasing the inductance value L.

### SUMMARY

An exemplary embodiment in the present disclosure may provide a chip electronic component capable of decreasing a direct current (DC) resistance value Rdc by increasing a cross-sectional area of a coil and implementing a high inductance value L by increasing an area of an internal magnetic part in which magnetic fluxes are formed.

According to an exemplary embodiment in the present disclosure, a chip electronic component may include: a magnetic body including an insulating substrate; an internal coil part formed on at least one surface of the insulating substrate; and an external electrode formed on at least one end surface of the magnetic body and connected to the internal coil part, wherein the internal coil part includes an outermost coil pattern portion, an innermost coil pattern portion and a central coil pattern portion, widths of the outermost and innermost coil pattern portions being greater than a width of the central coil pattern portion.

The width of the outermost coil pattern portion may be greater than that of the innermost coil pattern portion.

A ratio of the width of the outermost coil pattern portion to the width of the innermost coil pattern portion may be 1.1 to 1.2.

A ratio of the width of the outermost coil pattern portion or the innermost coil pattern portion to the width of the central coil pattern portion may be 1.1 to 1.3.

The widths of the outermost and innermost coil pattern portions may be 80 to 110 μm.

The width of the central coil pattern portion may be 70 to 90 μm.

The internal coil part may be formed of at least one selected from a group consisting of silver (Ag), palladium (Pd), aluminum (Al), nickel (Ni), titanium (Ti), gold (Au), copper (Cu), and platinum (Pt).

The insulating substrate may have a through hole formed in a central portion thereof, and the through hole may be filled with a magnetic material to form a core part.

The internal coil part may be formed on one surface and the other surface of the insulating substrate, and the internal coil part formed on one surface of the insulating substrate may be electrically connected to that formed on the other surface thereof through a via electrode formed in the insulating substrate.

According to an exemplary embodiment in the present disclosure, a chip electronic component may include: a magnetic body including an insulating substrate; an internal coil part formed on at least one surface of the insulating substrate; and an external electrode formed on at least one end surface of the magnetic body and connected to the internal coil part, wherein when a width of an outermost coil pattern portion of the internal coil part is a, a width of a central coil pattern portion thereof is b, and a width of an innermost coil pattern portion thereof is c, b<c≦a is satisfied.

A ratio a/c of the width a of the outermost coil pattern portion to the width c of the innermost coil pattern portion may be 1.1 to 1.2.

A ratio a/b of the width a of the outermost coil pattern portion to the width b of the central coil pattern portion may be 1.1 to 1.3.

The widths of the outermost and innermost coil pattern portions may be 80 to 110 μm.

The width of the central coil pattern portion may be 70 to 90 μm.

The internal coil part may be formed of at least one selected from a group consisting of silver (Ag), palladium (Pd), aluminum (Al), nickel (Ni), titanium (Ti), gold (Au), copper (Cu), and platinum (Pt).

The insulating substrate may have a through hole formed in a central portion thereof, and the through hole may be filled with a magnetic material to form a core part.

The internal coil parts may be formed on one surface and the other surface of the insulating substrate, and the internal coil part formed on one surface of the insulating substrate may be electrically connected to that formed on the other surface thereof through a via electrode formed in the insulating substrate.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic perspective view illustrating a chip electronic component including an internal coil part according to an exemplary embodiment of the present disclosure;

FIG. 2 is a cross-sectional view taken along line I-I′ of FIG. 1;

FIG. 3 is a schematic enlarged view of part A of FIG. 1; and

FIG. 4 is a cross-sectional view of a chip electronic component according to an exemplary embodiment of the present disclosure.

### DETAILED DESCRIPTION

Exemplary embodiments will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

### Chip Electronic Component

Hereinafter, a chip electronic component according to an exemplary embodiment of the present disclosure, particularly, a thin film inductor will be described. However, the present disclosure is not limited thereto.

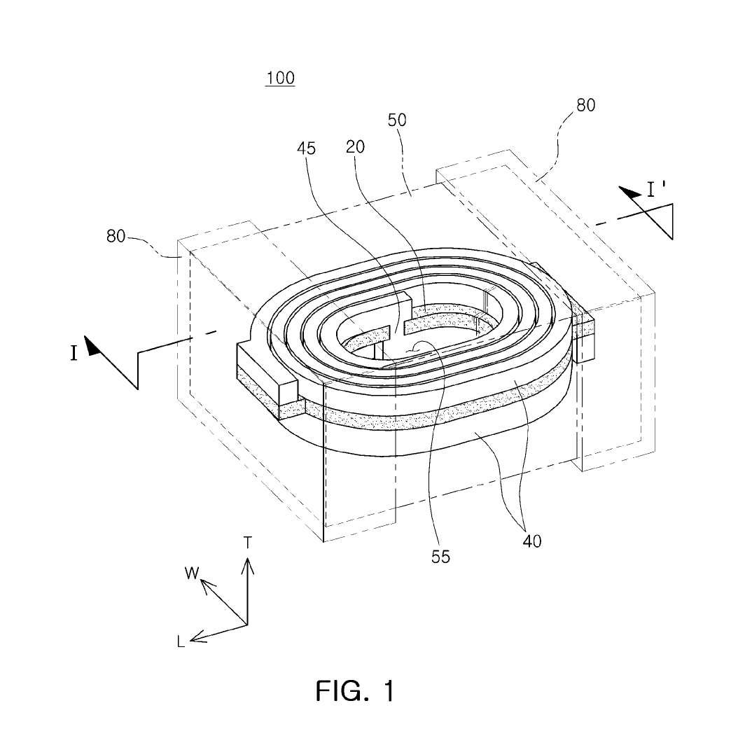

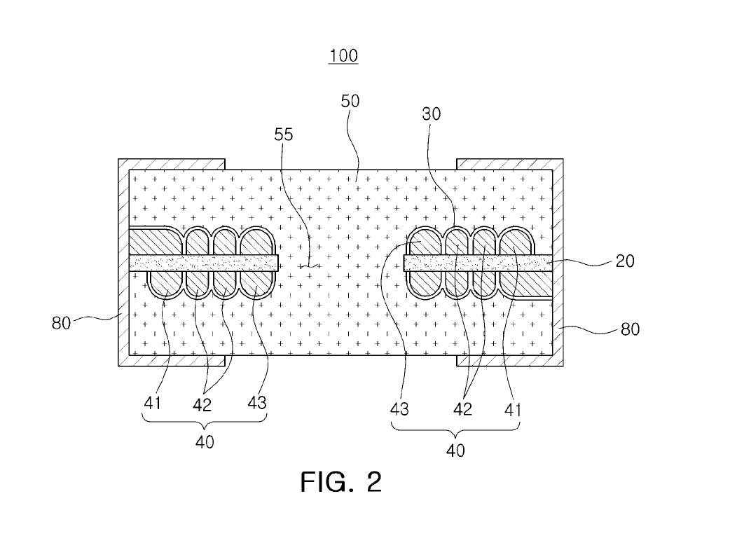

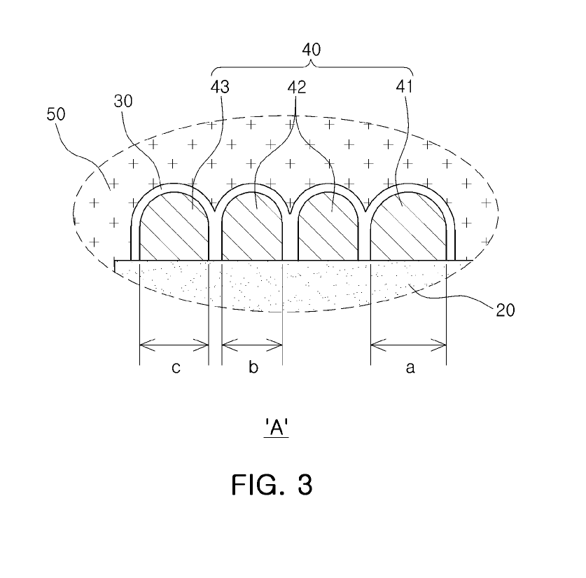

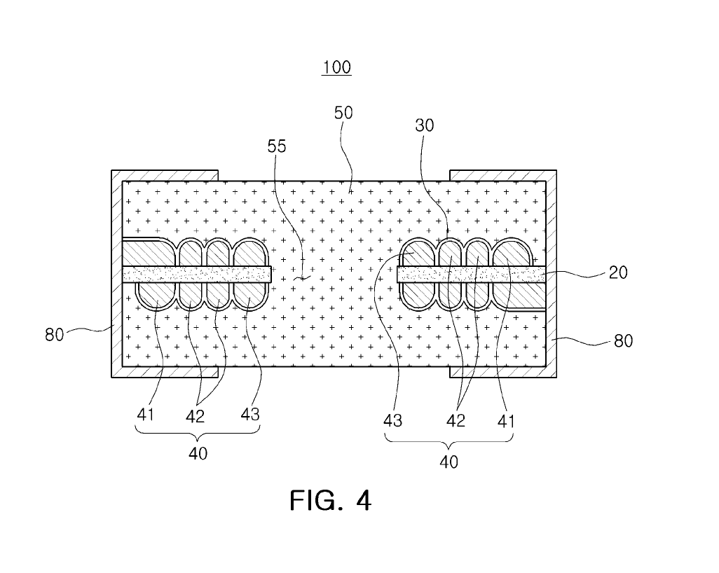

FIG. 1 is a schematic perspective view illustrating a chip electronic component including an internal coil part according to an exemplary embodiment of the present disclosure; FIG. 2 is a cross-sectional view taken along line I-I′ of FIG. 1; FIG. 3 is a schematic enlarged view of part A of FIG. 1; and FIG. 4 is a cross-sectional view of a chip electronic component according to an exemplary embodiment in the present disclosure.

Referring to FIGS. 1 and 2, a thin film inductor 100 used in a power line of a power supply circuit is illustrated as an example of a chip electronic component. The chip electronic component may be a chip bead, a chip filter, or the like, as well as the chip inductor.

The thin film inductor 100 may include a magnetic body 50, an insulating substrate 20, an internal coil part 40, and external electrodes 80.

The magnetic body 50 may form an exterior appearance of the thin film inductor 100 and may be formed of any material that exhibits magnetic properties. For example, the magnetic body 50 may be formed by filling ferrite or a metal based soft magnetic material.

The ferrite may be ferrite known in the art such as Mn—Zn based ferrite, Ni—Zn based ferrite, Ni—Zn—Cu based ferrite, Mn—Mg based ferrite, Ba based ferrite, Li based ferrite, or the like.

The metal based soft magnetic material may be an alloy containing at least one selected from a group consisting of Fe, Si, Cr, Al, and Ni. For example, the metal based soft magnetic material may contain Fe—Si—B—Cr based amorphous metal particles, but is not limited thereto.

The metal based soft magnetic material may have a particle diameter of 0.1 to 20 μm and be contained in a polymer such as an epoxy resin, polyimide, or the like, in a state in which it is dispersed in the polymer.

The magnetic body 50 may have a hexahedral shape. Directions of a hexahedron will be defined in order to clearly describe an exemplary embodiment of the present disclosure. L, W and T of a hexahedron shown in FIG. 1 refer to a length direction, a width direction, and a thickness direction, respectively. The magnetic body 50 may have a rectangular parallelepiped shape.

The insulating substrate 20 formed in the magnetic body 50 may be, for example, a polypropylene glycol (PPG) substrate, a ferrite substrate, a metal based soft magnetic substrate, or the like.

The insulating substrate 20 may have a through hole formed in a central portion thereof, wherein the through hole may be filled with a magnetic material such as ferrite, a metal based soft magnetic material, or the like, to form a core part 55. The core part 55 may be filled with the magnetic material, thereby increasing an inductance value L.

The internal coil part 40 may be formed on one surface and the other surface of the insulating substrate 20, respectively, wherein the internal coil part 40 may have a coil shaped pattern.

The internal coil part 40 may include a spiral shaped coil pattern, and the internal coil part 40 formed on one surface of the insulating substrate 20 may be electrically connected to that formed on the other surface of the insulating substrate 20 through a via electrode 45 formed in the insulating substrate 20.

Widths of the outermost coil pattern portion 41 and the innermost coil pattern portion 43 of the internal coil part 40 may be greater than a width of a central coil pattern portion 42 thereof. Here, a width of each coil pattern portion refers to a width of a lower surface of each coil pattern portion contacting the insulating substrate 20.

A direct current (DC) resistance value Rdc may be decreased by forming the coil pattern portions to have different widths, and a high inductance value L may be implemented by increasing an area of an internal magnetic part.

Referring to FIG. 3, when the width of the outermost coil pattern portion 41 is a, the width of the central coil pattern portion 42 is b, and the width of the innermost coil pattern portion 43 is c, b<c≦a may be satisfied.

The width a of the outermost coil pattern portion 41 and the width c of the innermost coil pattern portion 43 may be greater than the width b of the central coil pattern portion 42, and the width a of the outermost coil pattern portion 41 may be equal to or greater than the width c of the innermost coil pattern portion 43.

The central coil pattern portion 42 may be relatively narrow to increase an area of the magnetic part of the core part 55, thereby increasing the inductance value L, and the outermost coil pattern portion 41 and the innermost coil pattern portion 43 may be relatively wide to increase a cross-sectional area of the coil, thereby decreasing the DC resistance value Rdc. Particularly, the outermost coil pattern portion 41 having the greatest length may have the greatest width, such that the cross-sectional area of the coil may be significantly increased and the DC resistance value Rdc may be effectively decreased.

A ratio of the width of the outermost coil pattern portion 41 or the innermost coil pattern portion 43 to the width of the central coil pattern portion 42 may be 1.1 to 1.3.

In the case in which the ratio of the width of the outermost coil pattern portion 41 or the innermost coil pattern portion 43 to the width of the central coil pattern portion 42 is less than 1.1, the DC resistance value Rdc may be high, and in the case in which the ratio of the width of the outermost coil pattern portion 41 or the innermost coil pattern portion 43 to the width of the central coil pattern portion 42 exceeds 1.3, a short-circuit may occur between the coils, and the inductance value L may be lowered, such that it may be difficult to implement high capacitance.

A ratio of the width of the outermost coil pattern portion 41 to the width of the innermost coil pattern portion 43 may be 1.1 to 1.2.

The innermost coil pattern portion 43 and the outermost coil pattern portion 41 may have the same width. However, in the case in which the width of the outermost coil pattern portion 41 is greater than that of the innermost coil pattern portion 43, when the ratio of the width of the outermost coil pattern portion 41 to the width of the innermost coil pattern portion 43 is 1.1 to 1.2, the cross-sectional area of the coil may be more effectively increased with the area of the magnetic part of the core part 55 being increased.

The width of the innermost coil pattern portion 43 contacting the core part 55 may be smaller than that of the outermost coil pattern portion 41 to increase the area of the magnetic part of the core part 55, thereby increasing the inductance value L, and the width of the outermost coil pattern portion 41 having the greatest length may be greater than that of the innermost coil pattern portion 43 to increase the cross-sectional area of the coil and effectively decrease the DC resistance value Rdc.

For example, the widths of the outermost coil pattern portion 41 and the innermost coil pattern portion 43 may be 80 to 110 μm, and the width of the central coil pattern portion 42 may be 70 to 90 μm.

The internal coil part 40 may be formed of a metal having excellent electrical conductivity, for example, silver (Ag), palladium (Pd), aluminum (Al), nickel (Ni), titanium (Ti), gold (Au), copper (Cu), or platinum (Pt), an alloy thereof, or the like.

The internal coil part 40 may be coated with an insulating layer 30.

The insulating layer 30 may be formed by a method known in the art such as a screen printing method, a method for the exposure and development of a photoresist (PR), a spraying method, or the like. The internal coil part 40 may be coated with the insulating layer 30, such that it does not directly contact the magnetic material configuring the magnetic body 50.

One end portion of the internal coil part 40 formed on one surface of the insulating substrate 20 may be exposed to one end surface of the magnetic body 50 in the length direction of the magnetic body 50, and one end portion of the internal coil part 40 formed on the other surface of the insulating substrate 20 may be exposed to the other end surface of the magnetic body 50 in the length direction of the magnetic body 50.

The external electrodes 80 may be formed on both end surfaces of the magnetic body 50 in the length direction thereof, respectively, so as to be connected to the internal coil parts 40 exposed to the end surfaces of the magnetic body 50 in the length direction thereof. The external electrodes 80 may be extended to both end surfaces of the magnetic body 50 in the thickness direction thereof and/or both end surfaces of the magnetic body 50 in the width direction thereof.

The external electrode 80 may be formed of a metal having excellent electrical conductivity, for example, nickel (Ni), copper (Cu), tin (Sn), silver (Ag), or an alloy thereof.

The following Table 1 shows a DC resistance value Rdc, an inductance value L, and whether or not a short-circuit has occurred between coils depending on a ratio a/b of the width a of the outermost coil pattern portion 41 to the width b of the central coil pattern portion 42 of the internal coil part 40.

TABLE 1

| Width b of | Width a of | | | | |
|---|---|---|---|---|---|
| Central coil | Outermost coil | | | | |
| pattern | pattern | | | | Short-circuit |
| portion | portion | a/b | Rdc (mohm) | L (μH) | Probability |
| 80 μm | 120 μm | 1.5 | 79 | 0.85 | 30% |
| 80 μm | 104 μm | 1.3 | 85 | 0.93 | 0% |
| 80 μm | 88 μm | 1.1 | 92 | 0.97 | 0% |
| 80 μm | 80 μm | 1.0 | 100 | 1.0 | 0% |
| 80 μm | 72 μm | 0.9 | 115 | 1.04 | 0% |

As seen from the above Table 1, when the ratio of the width a of the outermost coil pattern portion to the width b of the central coil pattern portion is 1.1 to 1.3, a high inductance value has been obtained and a low DC resistance value Rdc has been obtained.

### Method of Manufacturing Chip Electronic Component

Next, a method of manufacturing a chip electronic component according to an exemplary embodiment of the present disclosure will be described.

First, the internal coil part 40 may be formed on at least one surface of the insulating substrate 20.

The insulating substrate 20 is not particularly limited, but may be, for example, a polypropylene glycol (PPG) substrate, a ferrite substrate, a metal based soft magnetic substrate, or the like, and may have a thickness of 40 to 100 μm.

A method of forming the internal coil part 40 may be, for example, an electroplating method, but is not limited thereto. The internal coil part 40 may be formed of a metal having excellent electrical conductivity, for example, silver (Ag), palladium (Pd), aluminum (Al), nickel (Ni), titanium (Ti), gold (Au), copper (Cu), platinum (Pt), an alloy thereof, or the like.

The widths of the outermost coil pattern portion 41 and the innermost coil pattern portion 43 of the internal coil part 40 may be greater than the width of the central coil pattern portion 42 thereof.

The coil pattern portions may have different widths by forming different widths of plating resists at the time of performing pattern plating or controlling a concentration of a plating solution and a current density at the time of performing electroplating.

A DC resistance value Rdc may be decreased by forming the coil pattern portions to have different widths, and a high inductance value L may be obtained by increasing an area of an internal magnetic part.

The width a of the outermost coil pattern portion 41 and the width c of the innermost coil pattern portion 43 may be greater than the width b of the central coil pattern portion, and the width a of the outermost coil pattern portion 41 may be equal to or greater than the width c of the innermost coil pattern portion 43.

The central coil pattern portion 42 may be relatively narrow to increase an area of the magnetic part of the core part 55, thereby increasing the inductance value L, and the outermost coil pattern portion 41 and the innermost coil pattern portion 43 may be relatively wide to increase a cross-sectional area of the coil, thereby decreasing the DC resistance value Rdc. Particularly, the outermost coil pattern portion 41 having the greatest length may have the greatest width, such that the cross-sectional area of the coil may be significantly increased and the DC resistance value Rdc may be effectively decreased.

A ratio of the width of the outermost coil pattern portion 41 or the innermost coil pattern portion 43 to the width of the central coil pattern portion 42 may be 1.1 to 1.3.

In the case in which the ratio of the width of the outermost coil pattern portion 41 or the innermost coil pattern portion 43 to the width of the central coil pattern portion 42 is less than 1.1, the DC resistance value Rdc may be high, and in the case in which the ratio of the width of the outermost coil pattern portion 41 or the innermost coil pattern portion 43 to the width of the central coil pattern portion 42 exceeds 1.3, a short-circuit may occur between the coils, and the inductance value L may be decreased, such that it may be difficult to implement high capacitance.

A ratio of the width of the outermost coil pattern portion 41 to the width of the innermost coil pattern portion 43 may be 1.1 to 1.2.

The innermost coil pattern portion 43 and the outermost coil pattern portion 41 may have the same width. However, in the case in which the width of the outermost coil pattern portion 41 is greater than that of the innermost coil pattern portion 43, when the ratio of the width of the outermost coil pattern portion 41 to the width of the innermost coil pattern portion 43 is 1.1 to 1.2, the cross-sectional area of the coil may be more effectively increased with the area of the magnetic part of the core part 55 being increased.

The width of the innermost coil pattern portion 43 contacting the core part 55 may be smaller than that of the outermost coil pattern portion 41 to increase the area of the magnetic part of the core part 55, thereby increasing the inductance value L, and the width of the outermost coil pattern portion 41 having the greatest length may be greater than that of the innermost coil pattern portion 43 to increase the cross-sectional area of the coil and effectively decrease the DC resistance value Rdc.

For example, the widths of the outermost coil pattern portion 41 and the innermost coil pattern portion 43 may be 80 to 110 μm, and the width of the central coil pattern portion 42 may be 70 to 90 μm.

A through hole may be formed in a portion of the insulating substrate 20 and be filled with a conductive material to form the via electrode 45, and the internal coil part formed on one surface of the insulating substrate 20 may be electrically connected to that formed on the other surface of the insulating substrate 20 through the via electrode 45.

The through hole may be formed in a central portion of the insulating substrate 20 by performing a drilling process, a laser process, a sand blast process, a punching process, or the like.

After the internal coil part 40 is formed, the insulating layer 30 coating the internal coil part 40 may be formed. The insulating layer 30 may be formed by a method known in the art such as a screen printing method, a method for the exposure and development of a photoresist (PR), a spraying method, or the like, but is not limited thereto.

Next, magnetic layers may be stacked on and below the internal coil part 40 formed on the insulating substrate 20, thereby forming the magnetic body 50.

The magnetic layers may be stacked on both surfaces of the insulating substrate 20 and be compressed by a lamination method or a hydrostatic pressing method, thereby forming the magnetic body 50. In this case, the hole may be filled with the magnetic material to form the core part 55.

Next, the external electrode 80 may be formed to be connected to the internal coil part 40 exposed to at least one end surface of the magnetic body 50.

The external electrode 80 may be formed of a paste containing a metal having excellent electrical conductivity, for example, a conductive paste containing nickel (Ni), copper (Cu), tin (Sn), silver (Ag), or an alloy thereof. The external electrode 80 may be formed by a dipping method, or the like, as well as a printing method, depending on a shape thereof.

A description of features that are the same as those of the chip electronic component according to the above-described embodiment of the present disclosure will be omitted.

As set forth above, according to exemplary embodiments of the present disclosure, a cross-sectional area of a coil is increased, whereby a DC resistance value Rdc may be decreased, and an area of an internal magnetic part in which magnetic fluxes are formed is increased, whereby a high inductance value L may be obtained.

While exemplary embodiments have been shown and described above, it will be apparent to those skilled in the art that modifications and variations could be made without departing from the spirit and scope of the present disclosure as defined by the appended claims.

What is claimed is:

1. A chip electronic component comprising:
a magnetic body including an insulating substrate;
an internal coil part disposed on at least one surface of the insulating substrate; and
an external electrode disposed on at least one end surface of the magnetic body and connected to the internal coil part,
wherein the internal coil part includes an outermost coil pattern portion, an innermost coil pattern portion and a central coil pattern portion, widths of the outermost and innermost coil pattern portions being greater than a width of the central coil pattern portion.

2. The chip electronic component of claim 1, wherein the width of the outermost coil pattern portion is greater than that of the innermost coil pattern portion.

3. The chip electronic component of claim 2, wherein a ratio of the width of the outermost coil pattern portion to the width of the innermost coil pattern portion is 1.1 to 1.2.

4. The chip electronic component of claim 1, wherein a ratio of the width of the outermost coil pattern portion or the innermost coil pattern portion to the width of the central coil pattern portion is 1.1 to 1.3.

5. The chip electronic component of claim 1, wherein the widths of the outermost and innermost coil pattern portions are 80 to 110 μm.

6. The chip electronic component of claim 1, wherein the width of the central coil pattern portion is 70 to 90 μm.

7. The chip electronic component of claim 1, wherein the internal coil part is formed of at least one selected from a group consisting of silver (Ag), palladium (Pd), aluminum (Al), nickel (Ni), titanium (Ti), gold (Au), copper (Cu), and platinum (Pt).

8. The chip electronic component of claim 1, wherein the insulating substrate has a through hole formed in a central portion thereof, and
the through hole is filled with a magnetic material to form a core part.

9. The chip electronic component of claim 1, wherein the internal coil part is formed on one surface and the other surface of the insulating substrate, and
the internal coil part formed on one surface of the insulating substrate is electrically connected to that formed on the other surface thereof through a via electrode formed in the insulating substrate.

10. A chip electronic component comprising:
a magnetic body including an insulating substrate;
an internal coil part disposed on at least one surface of the insulating substrate; and
an external electrode disposed on at least one end surface of the magnetic body and connected to the internal coil part,
wherein when a width of an outermost coil pattern portion of the internal coil part is a, a width of a central coil pattern portion thereof is b, and a width of an innermost coil pattern portion thereof is c, b<c≦a is satisfied.

11. The chip electronic component of claim 10, wherein a ratio a/c of the width a of the outermost coil pattern portion to the width c of the innermost coil pattern portion is 1.1 to 1.2.

12. The chip electronic component of claim 10, wherein a ratio a/b of the width a of the outermost coil pattern portion to the width b of the central coil pattern portion is 1.1 to 1.3.

13. The chip electronic component of claim 10, wherein the widths of the outermost and innermost coil pattern portions are 80 to 110 μm.

14. The chip electronic component of claim 10, wherein the width of the central coil pattern portion is 70 to 90 μm.

15. The chip electronic component of claim 10, wherein the internal coil part is formed of at least one selected from a group consisting of silver (Ag), palladium (Pd), aluminum (Al), nickel (Ni), titanium (Ti), gold (Au), copper (Cu), and platinum (Pt).

16. The chip electronic component of claim 10, wherein the insulating substrate has a through hole formed in a central portion thereof,
the through hole is filled with a magnetic material to form a core part.

17. The chip electronic component of claim 10, wherein the internal coil part is formed on one surface and the other surface of the insulating substrate, and
the internal coil part formed on one surface of the insulating substrate is electrically connected to that formed on the other surface thereof through a via electrode formed in the insulating substrate.
